(19) United States
(12) Patent Application Publication
(10) Pub. No.: US 2015/0040598 A1
(43) Pub. Date: Feb. 12, 2015

(54) Transport Refrigeration System With Regenerative Elements

(71) Applicant: Carrier Corporation, Farmington, CT (US)

(72) Inventors: John T. Steele, Marcellus, NY (US); Benjamin Edward Ferguson, Cazenovia, NY (US)

(21) Appl. No.: 14/366,404

(22) PCT Filed: Dec. 13, 2012
(86) PCT No.: PCT/US2012/069454

§ 371 Date: Jun. 18, 2014

Related U.S. Application Data
(60) Provisional application No. 61/577,142, filed on Dec. 19, 2011.

(51) Int. Cl. B60H 1/00; B60H 1/24; B60H 1/32

(52) U.S. Cl. CPC B60H 1/00428; B60H 1/32; B60H 1/24
USPC 62/239

(57) ABSTRACT

A transport refrigeration system (100) includes an engine (102), a primary power source (104) driven by the engine (102) and a secondary power source (106) driven by a vehicle component (108) upon vehicle braking. An energy storage unit (110) stores energy from the secondary power source (106). A power control unit (112) is coupled to the primary power source (104) and the energy storage unit (110). A controller (114) is coupled to the power control unit (112) and a refrigeration component (116, 118) is coupled to the power control unit (112). The controller (114) operates the power control unit (112) to distribute power to the refrigeration component (116, 118).

### BACKGROUND OF THE INVENTION

Embodiments of the invention relate generally to transport refrigeration, and more particularly to a transport refrigeration system with regenerative elements.

Existing transport refrigeration systems use an engine (e.g., gas or diesel engine) to drive refrigeration system components (e.g., compressor, fans). In order to improve efficiency and reduce emissions, hybrid systems have been proposed to power the transport refrigeration system. One hybrid system, described in U.S. Patent Application Publication 20110000244 and assigned to Carrier Corporation, uses an electrical hybrid power supply. While existing designs are well suited for their intended purposes, improvements in hybrid transport refrigeration systems would be well received in the art.

### BRIEF DESCRIPTION OF THE INVENTION

According to an exemplary embodiment of the present invention transport refrigeration system includes an engine; a primary power source driven by the engine; a secondary power source driven by a vehicle component upon vehicle braking; an energy storage unit that stores energy from the secondary power source; a power control unit coupled to the primary power source and the energy storage unit; a controller coupled to the power control unit; and a refrigeration component coupled to the power control unit; the controller operating the power control unit to distribute power to the refrigeration component.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a transport refrigeration system in exemplary embodiments; and

FIG. 2 depicts mounting of the transport refrigeration system of FIG. 1 to a trailer.

### DETAILED DESCRIPTION OF THE INVENTION

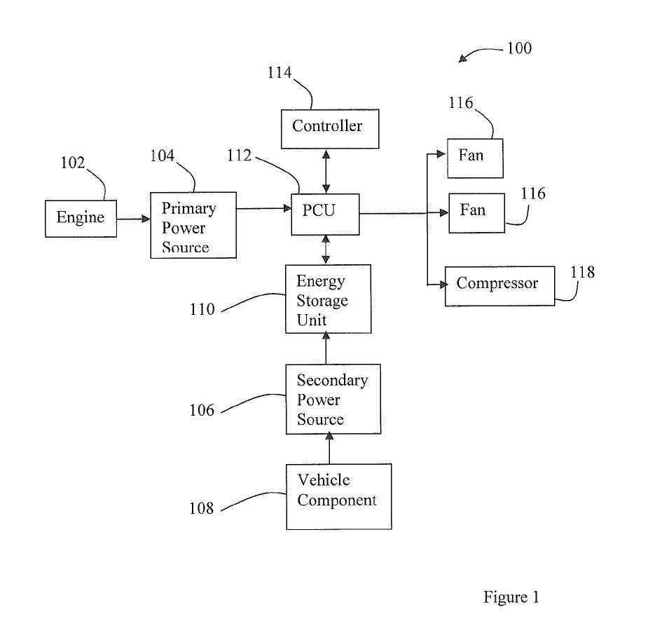

FIG. 1 depicts a transport refrigeration system 100 in exemplary embodiments. The transport refrigeration system 100 is employed along with a trailer, or other mobile compartment, requiring refrigeration. As described in further detail herein, the transport refrigeration system 100 uses regenerative power sources to power refrigeration components.

The transport refrigeration system 100 includes an engine 102 that drives a primary power source 104. Depending on the nature of the system, primary power source 104 may take different forms. In exemplary embodiments, primary power source 104 is an electrical generator. In alternate embodiments, primary power source 104 comprises a fluid motor (e.g., compressed air or hydraulic fluid).

Engine 102 may be a standalone engine (gas or diesel) or may be the engine of the vehicle directly driving primary power source 104 through, for example, a flywheel. Alternatively, the engine 102 may be a combination of a standalone engine and the engine of the vehicle operating in conjunction through mechanical coupling. This allows the run time of the standalone engine to be reduced, particularly during periods when the vehicle engine has extra capacity (e.g., vehicle idling).

The transport refrigeration system 100 includes a secondary power source 106 coupled to a trailer component 108. In exemplary embodiments, the trailer component is a brake component (e.g. drum or disc) and/or a wheel axle. The secondary power source 106 may comprise a regenerative brake that generates power during trailer braking. Regenerative brakes generate energy while the vehicle is braking by engaging a vehicle component and using the vehicle component kinetic energy to produce another form of energy. For example, a regenerative brake may include a generator that engages a wheel axle to simultaneously reduce rotation of the axle (i.e., provide braking) and generate electricity. Other regenerative brakes employ fluid pumps that engage a vehicle component to provide braking and pump a fluid used in the system.

The type of power generated by secondary power source 106 and primary power source 104 are similar. In other words, if primary power source is an electrical generator, then secondary power source 106 is a regenerative brake that generates electricity upon braking. Alternatively, if primary source is a motor (e.g. compressed air or hydraulic fluid), secondary power source 106 is a regenerative brake that pumps fluid upon braking.

Power from secondary power source 106 is stored in an energy storage unit 110. Energy storage unit 110 is configured depending on the nature of the power generated by primary power source 104 and secondary power source 106. Energy storage unit 110 may be a battery if primary power source 104 and secondary power source 106 produce electricity. Alternatively, the energy storage unit 110 may be a pressure tank for storing fluid under pressure if primary power source 104 and secondary power source 106 are fluid motors/pumps, respectively.

A power control unit (PCU) 112 operates in response to a controller 114 to direct power to and from energy storage unit 110, and to refrigeration components such as fans 116 (e.g., condenser fan and evaporator fan) and compressor 118. It is understood that other refrigeration components (e.g., condenser, evaporator, expansion valve, etc.) are not shown for ease of illustration. Controller 114 may be implemented using a microprocessor-based controller executing program code for carrying out the functions described herein. Controller 114 is connected to engine 102, primary power source 104, PCU 112, energy storage unit 110, secondary power source 106, and the refrigeration components to monitor and control these elements.

In operation, controller 114 monitors system conditions and instructs PCU 112 how to route power through the system. Controller 114 determines refrigeration demand based on temperature of the compartment to be cooled and a temperature setpoint. Controller 114 also detects that capacity of energy storage unit 110 and the RPM of engine 102. The PCU 112 conveys power to the refrigeration components from the primary power source 104, the energy storage unit 110, or both. The PCU 112 can also direct excess power from primary power source 104 to energy storage unit 110.

During periods of low refrigeration demand, for example, controller 114 may reduce the RPM of engine 102 (or turn off engine 102) and instruct the PCU 112 to power the refrigeration components from energy storage unit 110. Any excess power from primary power source 104 may be stored in energy storage unit 110. If energy storage unit 110 reaches some lower threshold capacity (e.g., 15% of capacity), engine 102 may be restarted to prevent complete drainage of energy from energy storage unit 110. Energy from primary power source 104 in excess of the refrigeration system demand may be stored in energy storage unit 110.

During periods of high refrigeration demand, controller 114 may instruct the PCU 112 to power the refrigeration components from primary power source 104 and increase the RPM of engine 102. Power from energy storage unit 110 may be used to augment power from primary power source 104, enabling a lower engine RPM to be used. Augmenting the primary power source 104 with the energy storage unit 110 allows the engine 102 to run less often, use lower RPM and/or be of smaller rating. If energy storage unit 110 reaches some lower threshold (e.g., 15% of capacity), RPM of engine 102 may be increased to prevent complete drainage of energy storage unit 110. Any excess power from primary power source 104 may be stored in energy storage unit 110.

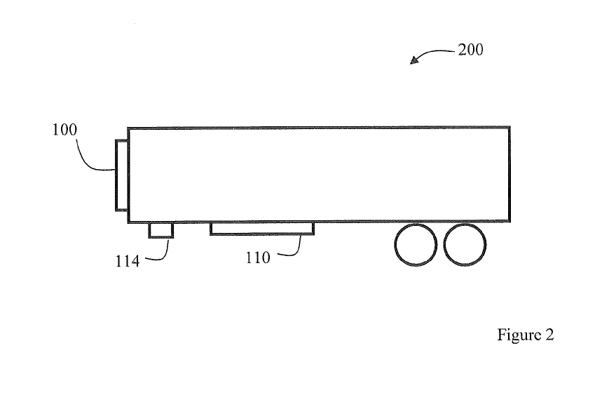

FIG. 2 depicts mounting of the transport refrigeration system 100 of FIG. 1 to a trailer 200. Trailer 200 is cooled by the refrigeration system. Energy storage unit 110 is mounted on the underside of trailer 200. Controller 114 is also mounted on the underside of the trailer. Other elements of system 100 from FIG. 1 may be mounted on the front of trailer 200.

Using regenerative brakes on trailer 200 to provide power to refrigeration components provides several benefits. The total cost of ownership is reduced, as the usage of engine 102 is augmented by the secondary power source. This results in less noise due to reduced engine operation. Additionally, a smaller engine may be used, further reducing noise and weight of the transport refrigeration system 100.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A transport refrigeration system comprising:
an engine;
a primary power source driven by the engine;
a secondary power source driven by a vehicle component upon vehicle braking;
an energy storage unit that stores energy from the secondary power source;
a power control unit coupled to the primary power source and the energy storage unit;
a controller coupled to the power control unit; and
a refrigeration component coupled to the power control unit;
the controller operating the power control unit to distribute power to the refrigeration component.

2. The transport refrigeration system of claim 1 wherein:
the primary power source comprises an electrical generator.

3. The transport refrigeration system of claim 2 wherein:
the secondary power source comprises an electrical generator.

4. The transport refrigeration system of claim 3 wherein:
the energy storage unit comprises a battery.

5. The transport refrigeration system of claim 1 wherein:
the primary power source comprises a fluid motor.

6. The transport refrigeration system of claim 5 wherein:
the secondary power source comprises is a fluid pump.

7. The transport refrigeration system of claim 6 wherein:
the energy storage unit comprises a pressure tank.

8. The transport refrigeration system of claim 5 wherein:
the fluid is hydraulic fluid.

9. The transport refrigeration system of claim 5 wherein:
the fluid comprises air.

10. The transport refrigeration system of claim 1 wherein:
the refrigeration component comprises a compressor.

11. The transport refrigeration system of claim 1 wherein:
the refrigeration component comprises a fan.
